(19) United States
(12) Patent Application Publication
(10) Pub. No.: US 2024/0309129 A1
(43) Pub. Date: Sep. 19, 2024

(54) COMPOSITION BASED ON (METH)ACRYLATE MONOMERS

(71) Applicants: Bostik SA, COLOMBES (FR); Universite De Haute-Alsace, MULHOUSE CEDEX (FR); Centre National De La Recherche Scientifique, PARIS (FR)

(72) Inventors: Jérôme MAZAJCZYK, VENETTE (FR); Stéphane FOUQUAY, Mont Saint Aignan (FR); Frédéric SIMON, Venette (FR); Guillaume MICHAUD, LYON (FR); Alexis BARRAT, VENETTE (FR); Jacques LALEVEE, MULHOUSE (FR)

(21) Appl. No.: 18/576,182

(22) PCT Filed: Jul. 11, 2022
(86) PCT No.: PCT/FR2022/051391

§ 371 Date: Jan. 3, 2024

(30) Foreign Application Priority Data
Jul. 12, 2021 (FR) FR2107544

(51) Int. Cl. C08F 120/28; C08F 4/10; C08K 5/03; C08K 5/3432; C09D 7/63; C09D 133/14; C09J 11/06; C09J 133/14

(52) U.S. Cl. CPC C08F 120/28; C08F 4/10; C08K 5/03; C08K 5/3432; C09D 7/63; C09D 133/14; C09J 11/06; C09J 133/14; C08K 2201/019; C09J 2433/00

(57) ABSTRACT

The present invention relates to a crosslinkable two-component composition comprising:
a component A comprising:
   an iodonium salt having one of the formulae (I-A), (I-B) or (I-C);
   at least one (meth)acrylate monomer M1 having one of the formulae (II), (III) or (IV);
   an organic or mineral acid having a pKa or pKa1 ranging from 0.3 to 5 measured in water at 25° C.;
   a copper salt or a copper complex;
   a component B comprising at least one dihydropyridine compound having one of the formulae (VI) to (X);
      said composition not comprising any peroxide.

### FIELD OF THE INVENTION

The present invention relates to a composition based on (meth)acrylate monomer.

The invention also relates to the use of said composition in the repair and/or the semi-structural or structural adhesive bonding of materials in the transportation, marine, assembly, electronics or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Typically, (meth)acrylic compositions comprise a peroxide (oxidizing agent)/tertiary amine (reducing agent) redox system. However, these systems may present storage stability problems in the presence of (meth)acrylate monomer.

There is a need for novel (meth)acrylic compositions which allow a good compromise between reactivity and storage stability.

In addition, there is also a need for novel (meth)acrylic compositions with good adhesive properties.

### DESCRIPTION OF THE INVENTION

### A. COMPOSITION

The present invention relates to a crosslinkable two-component composition comprising:
a component A comprising:
   an iodonium salt having one of the formulae (I-A), (I-B) or (I-C) below:

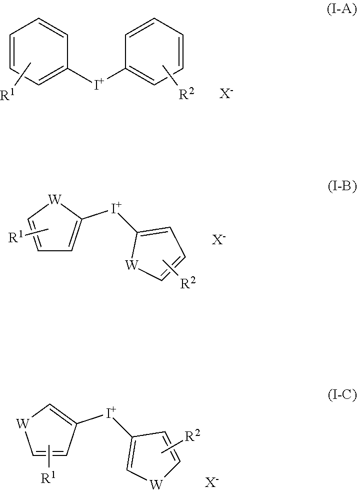

in which:
   R¹ and R² each represent, independently of each other, a hydrogen atom, an alkyl radical, an alkenyl radical, a cycloalkyl radical, a cycloalkenyl radical, an aryl radical, a chlorine atom, a bromine atom, an iodine atom, a carboxylic radical, or an —NO₂ radical;
   X⁻ represents a monovalent anion;
   W represents O or S;
at least one (meth)acrylate monomer M1 having one of the formulae (II), (III) or (IV) below:

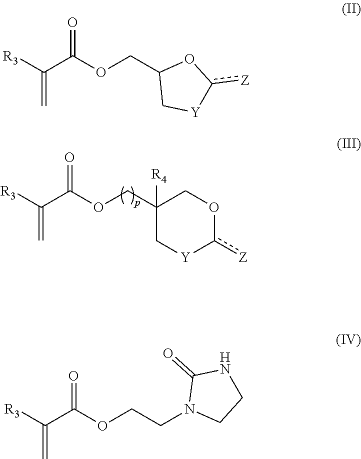

in which:
R³ represents H or a methyl;
R⁴ represents H, methyl or ethyl;
p represents 0 or 1; and
Z represents H, O, S, an alkyl group, a benzyl group, an aryl group or an alkoxy group;
Y represents O, S, NH or CH₂;
[symbol] is a single bond or a double bond,
on condition that when Z represents O, then the bond [symbol] is a double bond;
   an organic or mineral acid having a pKa or pKa1 ranging from 0.3 to 5.0 measured in water at 25° C.;
   optionally a copper salt of formula (V-1) or a copper complex of formula (V-2):

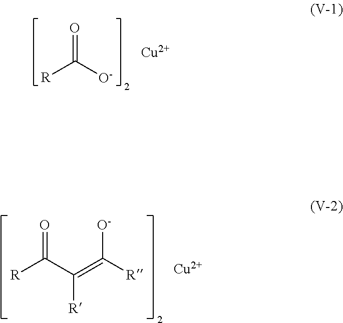

in which:
   R and R″ each represent, independently of each other, an alkyl radical, a cycloalkyl radical, an aryl radical or a heteroaryl radical,
   R′ represents a hydrogen atom, an alkyl radical, a cycloalkyl radical, an aryl radical or a heteroaryl radical,
   or R and R′ (or R′ and R″) may also be engaged in one and the same ring comprising from 5 to 8 carbon atoms, said ring optionally comprising at least one heteroatom (for instance O or S);
   a component B comprising at least one dihydropyridine compound having one of the formulae (VI) to (X) below:

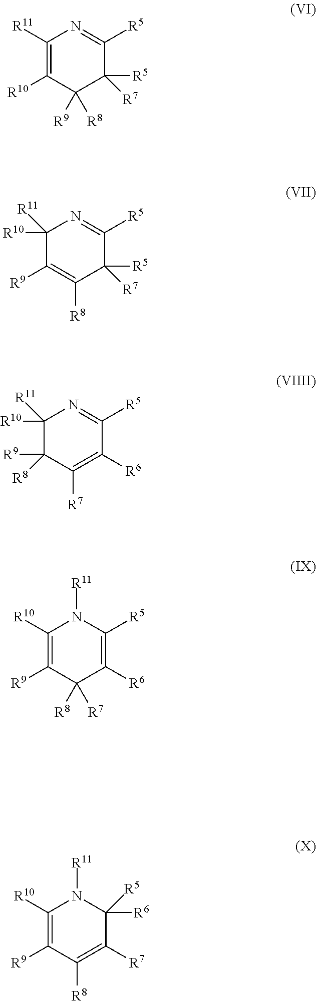

in which:
   each of the radicals R⁵ to R¹¹ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a};
   said alkyl, alkenyl, alkynyl, cycloalkyl, heterocycloalkyl, heteroalkyl, aryl, alkylaryl and arylalkyl groups being optionally substituted; and R^{a} represents an alkyl or aryl radical;
   or two radicals from among R⁵ to R¹¹ together form an optionally substituted monocyclic or polycyclic ring,
      said crosslinkable two-component composition not comprising any peroxide.

In the context of the invention, the term “alkyl” means a linear or branched radical preferably comprising from 1 to 20 carbon atoms. Mention may be made, for example, of methyl, ethyl and propyl.

In the context of the invention, the term “alkenyl” means a linear or branched hydrocarbon-based radical including at least one double bond, said radical preferably comprising from 2 to 20 carbon atoms. Examples that may be mentioned include propenyl and butenyl.

In the context of the invention, the term “alkynyl” means a linear or branched hydrocarbon-based radical including at least one triple bond, said radical preferably comprising from 2 to 20 carbon atoms.

In the context of the invention, the term “aryl” means a monocyclic or bicyclic aromatic radical preferably comprising from 6 to 12 carbon atoms. Mention may be made, for example, of phenyl.

In the context of the invention, the term “arylalkyl” means an alkyl group substituted with an aryl group, the arylalkyl group preferably comprising from 7 to 20 carbon atoms. As an arylalkyl group, mention may be made, for example, of benzyl.

In the context of the invention, the term “alkylaryl” means an aryl group substituted with an alkyl group, said alkylaryl group preferably comprising from 7 to 20 carbon atoms.

In the context of the invention, the term “heteroaryl” means a monocyclic or bicyclic aromatic radical comprising at least one heteroatom, for instance O, S or N, and preferably comprising from 4 to 12 carbon atoms. Examples that may be mentioned include furanyl, thiophenyl, pyrrolyl, pyridinyl, indolyl or imidazolyl radicals.

In the context of the invention, the term “cycloalkyl” means a monocyclic or polycyclic, preferably monocyclic or bicyclic, saturated system preferably including from 3 to 12 carbon atoms, the rings possibly being bridged or fused in pairs, such as cyclopropyl, cyclopentyl, cyclohexyl or norbornyl groups.

In the context of the invention, the term “heterocycloalkyl” means a monocyclic or polycyclic, preferably monocyclic or bicyclic, saturated system, preferably including from 3 to 12 carbon atoms and at least one heteroatom, for instance O or N, the rings possibly being fused or bridged in pairs.

In the context of the invention, the term “cycloalkenyl” means a monocyclic or polycyclic system comprising at least one double bond, preferably including from 3 to 12 carbon atoms, the rings possibly being fused or bridged in pairs.

In the context of the invention, the term “alkoxy” means an —O-alkyl radical.

### Component A

### Iodonium Salt of Formula (I-A), (I-B) or (I-C)

Component A comprises an iodonium salt having one of the formulae (I-A), (I-B) or (I-C) as defined above.

Preferably, in the abovementioned formulae (I-A), (I-B) and (I-C), R¹ and R² each represent, independently of each other, an alkyl radical or a hydrogen atom.

In the abovementioned formulae (I-A), (I-B) and (I-C), X⁻ may represent F⁻, Cl⁻, Br⁻, I⁻, NO₃⁻, HSO₄⁻, H₂PO₄⁻, HCOO⁻, CH₃COO⁻, BF₄⁻, AsF₆⁻, PF₆⁻, CH₃—Ph—SO₃⁻, (F₅Ph)₄B⁻ or SbF₆⁻. Preferably, in the abovementioned formulae (I-A), (I-B) and (I-C), X⁻ represents BF₄⁻, PF₆⁻, CH₃—Ph—SO₃⁻, (F₅Ph)₄B⁻ or SbF₆⁻. Even more preferentially, X⁻ represents the anion (F₅Ph)₄B⁻ of the following formula:

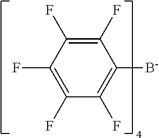

Among the iodonium salts of formula (I-B), mention may be made, for example, of:

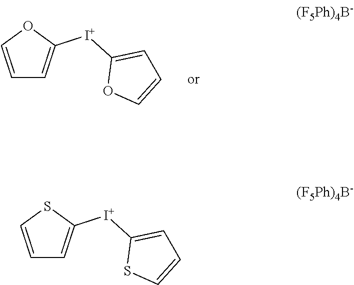 [SMILES: c1coc([I+]c2ccco2)c1 ; c1csc([I+]c2cccs2)c1]

Among the iodonium salts of formula (I-C), mention may be made, for example, of:

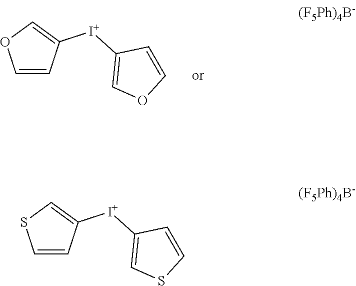 [SMILES: c1cc([I+]c2ccoc2)co1 ; c1cc([I+]c2ccsc2)cs1]

Among the iodonium salts of formula (I-A), mention may be made, for example, of diphenyliodonium hexafluorophosphate, diphenyliodonium fluoroborate, diphenyliodonium 2-carboxylate, bis(4-tert-butylphenyl)iodonium hexafluorophosphate, 3,3′-dimethyldiphenyliodonium hexafluorophosphate and (4-isopropylphenyl)(4-methylphenyl)iodonium tetrakis(pentafluorophenyl)borate.

Preferably, the iodonium salt is a salt of formula (I-A). Even more preferably, the iodonium salt is (4-isopropylphenyl)(4-methylphenyl)iodonium tetrakis(pentafluorophenyl)borate having the following formula:

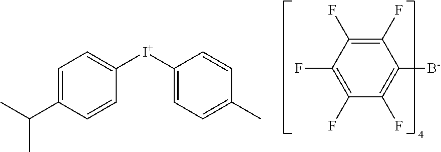

This iodonium salt advantageously allows the stability of the composition to be improved over time, for example up to 30 days at 40° C. in air.

The iodonium salts of formula (I-A) may be prepared as described in US 4 151 175 or US 4 238 394. The iodonium salts of formula (I-B) may be prepared as described in Journal of Fluorine Chemistry (2009), 130(5), 501-504. The iodonium salts of formula (I-C) may be prepared as described in Journal of Heterocyclic Chemistry (1977), 14(2), 281-8.

The total content of iodonium salt of formula (I-A), (I-B) or (I-C) may range from 0.05% to 5.0% by weight, preferably from 0.1% to 3.0% by weight, even more preferentially from 0.1% to 1.5% by weight relative to the total weight of the crosslinkable two-component composition.

### (Meth)Acrylate Monomer M1

Component A according to the invention comprises at least one (meth)acrylate monomer M1 having one of the formulae (II), (III) or (IV) below:

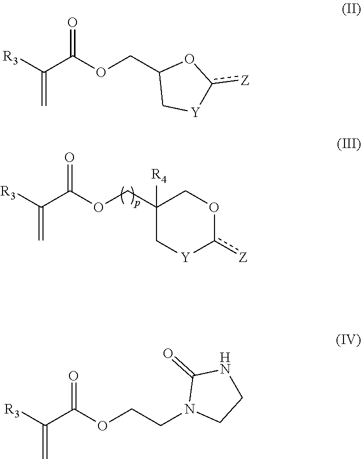

in which:
R³ represents H or methyl;
R⁴ represents H, methyl or ethyl;
p represents 0 or 1; and
Z represents H, O, S, an alkyl group, a benzyl group, an aryl group or an alkoxy group;
Y represents O, S, NH or CH₂—;
[symbol] is a single bond or a double bond,
on condition that when Z represents O, then the bond [symbol] is a double bond.

The (meth)acrylate monomer M1 may be chosen from the following monomers:

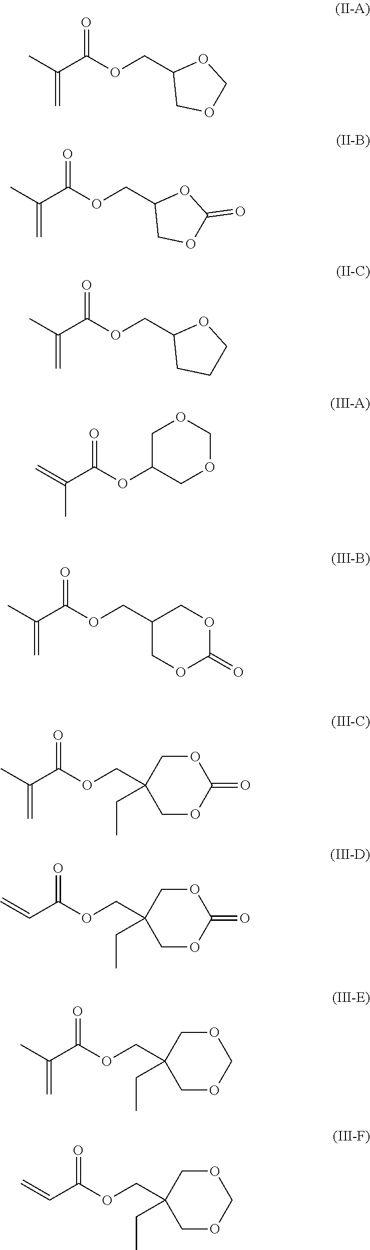

The monomer M1 is preferably chosen from the monomers of formula (II) or (III). It is even more preferentially one of the following compounds or mixtures thereof:

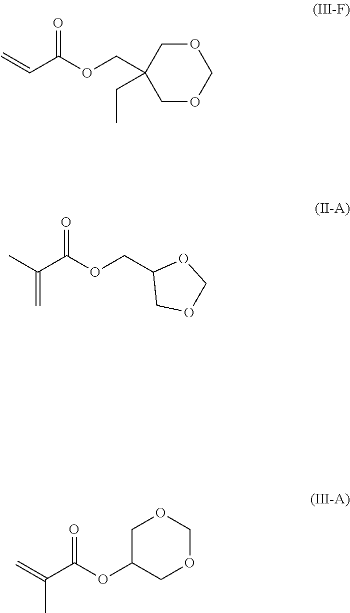

The total content of (meth)acrylate monomer(s) M1 in component A may be greater than or equal to 20% by weight relative to the total weight of said component A.

The content of (meth)acrylate monomer(s) M1 in the crosslinkable two-component composition according to the invention may range from 20% to 99% by weight, preferably from 50% to 99% by weight and even more preferentially from 75% to 99% by weight relative to the total weight of said crosslinkable two-component composition.

### Organic or Mineral Acid

Component A comprises an organic or mineral acid having a pKa or pKa1 ranging from 0.3 to 5 measured in water at 25° C.

The pKa (or acidity constant) is defined by pKa=−log₁₀ Ka, where Ka is the acid dissociation constant which is measured in the standard manner at 25° C. The recommended standard measurement method for pKa is notably potentiometry, and more precisely pH-metry, as described, for example, in Techniques de l'ingénieur [Engineering Techniques] (ref. K695 v1). This is the method most commonly used for determining pKa.

The pka1 is defined by pKa1=−log₁₀ Ka1, where Ka1 is the acid dissociation constant of the first strongest acidity of the polyacids. Ka2 is the acid dissociation constant of the second acidity of the polyacids (where appropriate) and Ka3 is the acid dissociation constant of the third weakest acidity of the polyacids (where appropriate). Each successive acidity of a polyacid pKa1, pKa2 or pKa3 corresponds notably to decreasing values of the acidity constants Ka1, Ka2 and Ka3. The same standard potentiometric measurement indicated previously is used to measure them.

Among the organic acids, mention may be made, for example, of carboxylic acids, phosphorus-based acids and mixtures thereof.

Among the carboxylic acids, mention may be made, for example, of formic acid, acetic acid, monochloroacetic acid, monofluoroacetic acid, dichloroacetic acid, difluoroacetic acid, propionic acid, malic acid, fumaric acid, malonic acid, succinic acid, maleic acid, fumaric acid, citric acid, acrylic acid, methacrylic acid, cyanoacetic acid, salicylic acid, itaconic acid, benzoic acid, glycolic acid, thioglycolic acid, pyruvic acid, cinnamic acid, and mixtures thereof.

Among the mineral acids, mention may be made, for example, of phosphoric acid, phosphorous acid, methylphosphonic acid, hypophosphorous acid and mixtures thereof.

According to one embodiment, the acid has a pka or pka1 ranging from 2 to 5, and notably from 4 to 5.

According to a preferred embodiment, the acid having a pKa or pka1 ranging from 0.3 to 5 is an organic acid chosen from carboxylic acids, and even more preferentially chosen from acrylic acid, methacrylic acid, itaconic acid, salicylic acid, benzoic acid, monochloroacetic acid, monofluoroacetic acid, dichloroacetic acid, difluoroacetic acid and mixtures thereof. Even more preferably, the acid having a pKa or pka1 ranging from 0.3 to 5 is an organic acid chosen from monochloroacetic acid, monofluoroacetic acid, dichloroacetic acid, difluoroacetic acid and mixtures thereof. Even more preferably, it is dichloroacetic acid or difluoroacetic acid.

The total content of acid having a pka or pka1 ranging from 0.3 to 5 may range from 0.1% to 20% by weight, preferably from 0.1% to 10% by weight, and even more preferentially from 0.2% to 2% by weight relative to the total weight of the crosslinkable two-component composition.

### Copper Salt of Formula (V-1) or Copper Complex of Formula (V-2)

Component A may comprise a copper salt of formula (V-1) or a copper complex of formula (V-2):

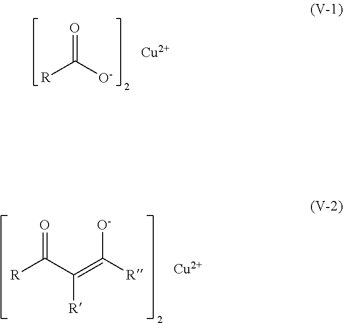

in which:
   R and R″ each represent, independently of each other, an alkyl radical, a cycloalkyl radical, an aryl radical or a heteroaryl radical,
   R′ represents a hydrogen atom, an alkyl radical, a cycloalkyl radical, an aryl radical or a heteroaryl radical,
   or R and R′ (or R′ and R″) may also be engaged in one and the same ring comprising from 5 to 8 carbon atoms, said ring optionally comprising at least one heteroatom (for instance O or S).

Preferably, the salt of formula (V-1) is that in which R represents an alkyl, even more preferentially a methyl.

Preferably, the salt of formula (V-2) is that in which:
R and R″ each represent, independently of each other, an alkyl radical, a cycloalkyl radical, an aryl radical, a heteroaryl radical, preferably an alkyl radical;
R′ represents a hydrogen.

The salt of formula (V-1) is preferably copper acetate.

The copper complex of formula (V-2) is preferably copper acetylacetonate.

The total content of metal complex(es) of formula (V-2) may range from 0 ppm to 3000 ppm by weight, preferably from 10 ppm to 2000 ppm by weight, preferentially from 200 ppm to 2000 ppm by weight, even more preferentially from 500 ppm to 1500 ppm by weight relative to the total weight of the crosslinkable two-component composition.

### Component B

### Dihydropyridine Compound of Formulae (VI) to (X)

Component B comprises at least one dihydropyridine compound having one of the formulae (VI) to (X) as defined above.

The dihydropyridine compound may be chosen from those of formulae (VI) to (X) in which:
R¹¹ represents an aryl or heteroaryl, said aryl or heteroaryl being optionally substituted, and
R⁵ to R¹⁰ represents, independently of each other, a hydrogen, an alkyl, an alkenyl, an alkynyl, a cycloalkyl, a heterocycloalkyl, a heteroaryl, an aryl, an alkylaryl, an arylalkyl,
R⁵ to R¹⁰ preferably representing, independently of each other, a hydrogen or an alkyl.

According to a preferred embodiment, the dihydropyridine compound has the formula (IX) or (X) as defined previously.

The dihydropyridine compound may be chosen from the following compounds:

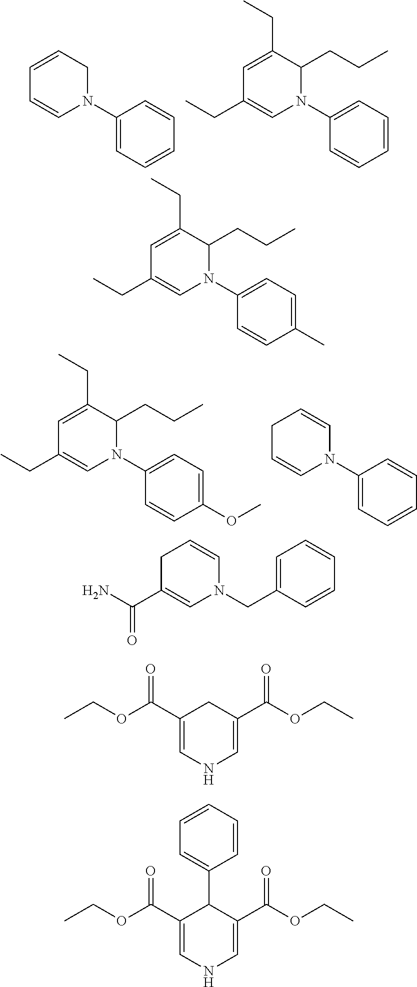

According to a preferred embodiment, the dihydropyridine is the following compound:

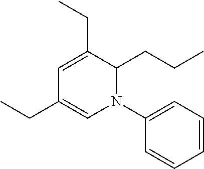 [SMILES: CCCC1C(CC)=CC(CC)=CN1c1ccccc1]

The dihydropyridines may be commercially available, for instance Vanax 808 HP sold by the company Vanderbilt Chemicals, or may be synthesized as described, for example, in WO 2006/086602.

The total content of dihydropyridine compound(s) having one of the formulae (VI) to (X) as defined previously may range from 0.05% to 5.0% by weight, preferably from 0.1% to 3.0% by weight, and even more preferentially from 0.1% to 1.5% by weight relative to the total weight of the crosslinkable two-component composition.

In the crosslinkable two-component composition according to the invention, the mole ratio of dihydropyridine compound(s) of formulae (VI) to (X)/iodonium salt(s) of formula (I-A) or (I-B) or (I-C) may range from 0.25 to 9, preferably from 0.5 to 6, and even more preferentially from 0.9 to 3.

### Composition

The crosslinkable two-component composition according to the invention may comprise at least one other (meth)acrylate monomer M2 different from the monomer M1, and may be present in component A and/or component B.

The (meth)acrylate monomer(s) M2 may be chosen from the group consisting of:
compounds having the formula (XI) below:

H₂C═C(R¹²)—COOR¹³ (XI)
in which:
   R¹² represents a hydrogen atom or a methyl group;
   R¹³ is chosen from the group consisting of alkyls, cycloalkyls, alkenyls, cycloalkenyls, alkylaryls, arylalkyls or aryls, said alkyls, cycloalkyls, alkenyls, cycloalkenyls and alkylaryls possibly being optionally substituted with and/or interrupted with at least one silane, silicone, oxygen, halogen, carbonyl, hydroxyl, ester, urea, urethane, carbonate, amine, amide, sulfur, sulfonate or sulfone;
polyethylene glycol di(meth)acrylates;
tetrahydrofuran (meth)acrylates;
hexanediol di(meth)acrylate;
trimethylolpropane tri(meth)acrylate;
diethylene glycol di(meth)acrylate;
triethylene glycol di(meth)acrylate;
tetraethylene glycol di(meth)acrylate;
dipropylene glycol di(meth)acrylate;
di(pentamethylene glycol) di(meth)acrylate;
diglycerol tetra(meth)acrylate;
tetramethylene di(meth)acrylate;
ethylene di(meth)acrylate;
bisphenol A mono- and di(meth)acrylates;
bisphenol F mono- and di(meth)acrylates; and
mixtures thereof.

The (meth)acrylate monomer M2 may notably be chosen from methyl (meth)acrylate, ethyl (meth)acrylate, butyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, 3-vinylcyclohexyl (meth)acrylate, bornyl (meth)acrylate, 2,4,5-tri-t-butyl-3-vinylcyclohexyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, and mixtures thereof.

The content of (meth)acrylate monomer(s) M2 in the two-component composition according to the invention may range from 0% to 69% by weight, preferably from 0% to 49% by weight, and even more preferentially from 0% to 24% by weight, relative to the total weight of said composition.

The content of the total sum of (meth)acrylate monomer(s) M2 and monomer(s) M1 in the two-component composition according to the invention may range from 30% to 99% by weight, preferably from 50% to 99% by weight, and even more preferentially from 75% to 99% by weight, relative to the total weight of said composition.

According to one embodiment, the abovementioned two-component composition does not comprise any hydroxyalkyl (meth)acrylate.

Component B as defined above may comprise at least one methacrylate monomer M1 as defined above.

Preferably, component B comprises more than 50% by weight of monomer M1, even more preferentially more than 70% by weight, and even more advantageously more than 90% by weight, relative to the total weight of said component B.

The crosslinkable two-component composition according to the invention may comprise at least one additive chosen from the group consisting of catalysts, fillers, antioxidants, light stabilizers/UV absorbers, metal deactivators, antistatic agents, film-preventing agents, foaming agents, biocides, plasticizers, lubricants, emulsifiers, dyes, pigments, rheological agents, impact modifiers, adhesion promoters, optical brighteners, flame retardants, anti-sweating agents, nucleating agents, solvents, accelerators, and mixtures thereof.

These additives may be present in component A and/or component B of the composition according to the invention.

An example of an accelerator that may be mentioned is saccharin.

As examples of plasticizers that may be used, mention may be made of any plasticizer normally used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Use may be made, for example, of:
diisodecyl phthalate, as sold, for example, under the name Palatinol™ DIDP by the company BASF,
an ester of alkylsulfonic acid and of phenol, as sold, for example, under the name Mesamoll® by the company Lanxess,
diisononyl 1,2-cyclohexanedicarboxylate, as sold, for example, under the name Hexamoll Dinch® by the company BASF,
pentaerythrityl tetravalerate, as sold, for example, under the name Pevalen™ by the company Perstorp,
the epoxidized soya bean oil as sold, for example, under the name Vikoflex® 7170 by the company Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols may be those described in particular in the publication “Polyurethane Sealants”, Robert M. Evans, ISBN 087762-998-6,
fumed silica, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described notably in patent application FR 1 591 172;
micronized amide waxes, such as Crayvallac® SLT or Crayvallac® SLA sold by Arkema.

The composition according to the invention may also comprise at least one organic and/or mineral filler.

The mineral filler(s) that may be used are advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

Preferably, the filler(s) are chosen from the group consisting of clay, quartz, carbonate fillers, kaolin, gypsum, clays and mixtures thereof; preferentially, the filler(s) are chosen from carbonate fillers, such as alkali metal or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, for instance the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl(2-methacryloyloxyethyl phosphate), ethyl(2-methacryloyloxyethyl phosphate), a mixture of 2-hydroxyethyl methacrylate mono- and diphosphate esters.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight relative to the total weight of the composition.
The pigments may be organic or inorganic pigments.

For example, the pigment is TiO₂, in particular Kronos® 2059 sold by the company Kronos.

The composition may comprise an amount of from 0.1% to 3%, preferably from 1% to 3%, by weight of at least one UV stabilizer or antioxidant. These compounds are typically introduced in order to protect the composition from degradation resulting from a reaction with oxygen which is liable to be formed by the action of heat or light. These compounds may include primary antioxidants which trap free radicals. The primary antioxidants can be used alone or in combination with other secondary antioxidants or UV stabilizers.

Mention may be made, for example, of Irganox® 1010, Irganox® B561, Irganox® 245, Irgafos® 168, Tinuvin® 328 or Tinuvin™ 770, which are sold by BASF.

In the composition according to the invention, the component A/component B volume ratio may range from 20/1 to 1/1, preferentially from 10/1 to 1/1.

Preferably, the composition according to the invention comprises:
a component A comprising:
   an iodonium salt having one of the formulae (I-A), (I-B) or (I-C) below:

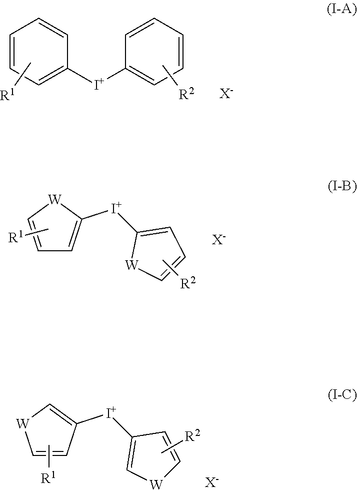

in which R¹ and R^{2,} X⁻and W are as defined previously, X− preferably representing the anion (F₅Ph)₄B⁻;
   at least one (meth)acrylate monomer M1 having one of the formulae (II), (III) or (IV) as defined previously;
   an organic acid chosen from monochloroacetic acid, monofluoroacetic acid, dichloroacetic acid, difluoroacetic acid and mixtures thereof;
   optionally a copper salt of formula (V-1) or a copper complex of formula (V-2) as defined previously;
   a component B comprising:
      at least one dihydropyridine compound as defined previously;
      at least one methacrylate monomer M1 as defined previously, preferably in a content greater than 50% by weight, more preferentially greater than 70% by weight, and even more advantageously greater than 90% by weight, relative to the total weight of said component B;
         said crosslinkable two-component composition not comprising any peroxide.

### B. READY-TO-USE KIT

The present invention also relates to a ready-to-use kit, comprising both component A as defined above and component B as defined above, packaged in two separate compartments. It may, for example, be a two-component cartridge.

Indeed, the composition according to the invention may be in a two-component form, for example in a ready-to-use kit, comprising both component A in a first compartment or drum and component B in a second compartment or drum, in proportions suitable for direct mixing of the two components, for example using a metering pump.

According to one embodiment of the invention, the kit also comprises one or more means for mixing components A and B. Preferably, the mixing means are chosen from metering pumps or static mixers with a diameter suited to the amounts used.

### C. USES OF THE COMPOSITION

The present invention also relates to the use of a crosslinkable two-component composition as defined above as adhesive, mastic or coating, preferably as adhesive.

The invention also relates to the use of said composition in the repair and/or the structural or semi-structural adhesive bonding of materials in the transportation, motor vehicle (car, bus or truck), assembly, marine, electronics or construction field.

The present invention relates to a process for assembling two substrates by adhesive bonding, involving:
the coating, onto at least one of the two substrates to be assembled, of a composition obtained by mixing components A and B as defined above; and then
bringing the two substrates into effective contact;
crosslinking the composition.

The crosslinking step may be performed at a temperature of between 0° C. and 200° C., preferably between 10° C. and 150° C., preferably between 23 and 80° C. and in particular between 20° C. and 25° C.

The appropriate substrates are, for example, inorganic substrates, such as concrete, metals or alloys (such as aluminum alloys, steel, non-ferrous metals and galvanized metals); or else organic substrates, such as wood, plastics such as PVC, polycarbonate, PMMA, polyethylene, polypropylene, polyesters, epoxy resins; substrates made of metal and composites coated with paint.

The crosslinking may be performed under electromagnetic irradiation, for instance with a UV radiation source or an LED.

The crosslinking step under electromagnetic irradiation may be performed at a wavelength greater than 300 nm, preferably ranging from 360 nm to 680 nm, and even more preferentially from 360 nm to 420 nm.

The compositions according to the invention advantageously do not comprise any peroxide. The compositions according to the invention advantageously allow a good compromise between stability on storage and high reactivity.

The compositions according to the invention advantageously have, after crosslinking, good adhesive properties.

In addition, the surface of the crosslinked compositions advantageously dries rapidly and may be tack-free, thereby notably making it possible to increase the productivity of industrial processes.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following ingredients were used:
SR® 531: cyclic trimethylolpropane formal acrylate (CAS: 66492-51-1) sold by Arkema;
Speedcure® 939: (4-isopropylphenyl)(4-methylphenyl)iodonium tetrakis(pentafluoro-phenyl)borate (CAS: 178233-72-2) sold by Lambson;
methyl methacrylate (MMA): sold by Arkema;
Vanax® 808 HP: 3,5-diethyl-1,2-dihydro-1-phenyl-2-propylpyridine (CAS: 34562-31-7) sold by Vertellus Specialties;
Cu(Acac)₂: copper(II) bis(acetylacetonate) (CAS: 13395-16-9) available from Sigma-Aldrich;
Cu(OAc)₂ (CAS: 142-71-2): copper(II) acetate available from Aldrich;
Difluoroacetic acid (CAS: 381-73-7) available from Sigma-Aldrich.

### Example 1: Preparation of Composition 1

The ingredients of component A are mixed in the proportions shown in the following table, at a temperature of 23° C., in a continuously stirred mixer and under nitrogen. The various ingredients constituting component B are mixed in the proportions shown in the following table, at a temperature of 23° C., in a continuously stirred mixer and under nitrogen.

Composition 1

| Component A | | Component B | |
|---|---|---|---|
| | % by weight | | % by weight |
| | (relative to | | (relative to |
| | the total | | the total |
| Ingredients | weight of A) | Ingredients | weight of B) |
| Trimethylolpropane | 97 | Trimethylolpropane | 99 |
| formal acrylate | | formal acrylate | |
| (SR ® 531) | | (SR ® 531) | |
| Speedcure ® 939 | 2 | Vanax ® 808 HP | 1 |
| Difluoroacetic acid | 1 | | |
| TOTAL | 100 | TOTAL | 100 |

Component A and component B are mixed, in a 1:1 volume ratio using a Sulzer ® Mixpac mixer at an ambient temperature of 23° C.

### Example 2: Preparation of Composition 2

The ingredients of component A are mixed in the proportions shown in the following table, at a temperature of 23° C., in a continuously stirred mixer and under nitrogen. The various ingredients constituting component B are mixed in the proportions shown in the following table, at a temperature of 23° C., in a continuously stirred mixer and under nitrogen.

Composition 2

| Component A | | Component B | |
|---|---|---|---|
| | % by weight | | % by weight |
| | (relative to | | (relative to |
| | the total | | the total |
| Ingredients | weight of A) | Ingredients | weight of B) |
| Trimethylolpropane | 96.8 | Trimethylolpropane | 99 |
| formal acrylate | | formal acrylate | |
| (SR ® 531) | | (SR ® 531) | |
| Speedcure ® 939 | 2 | Vanax ® 808 HP | 1 |
| Cu(Acac)₂ | 0.2 | | |
| Difluoroacetic acid | 1 | | |
| TOTAL | 100 | TOTAL | 100 |

Component A and component B are mixed, in a 1:1 volume ratio using a Sulzer ® Mixpac mixer at an ambient temperature of 23° C.

### Example 3: Preparation of Composition 3

The ingredients of component A are mixed in the proportions shown in the following table, at a temperature of 23° C., in a continuously stirred mixer and under nitrogen. The various ingredients constituting component B are mixed in the proportions shown in the following table, at a temperature of 23° C., in a continuously stirred mixer and under nitrogen.

Composition 3

| Component A | | Component B | |
|---|---|---|---|
| | % by weight | | % by weight |
| | (relative to | | (relative to |
| | the total | | the total |
| Ingredients | weight of A) | Ingredients | weight of B) |
| Trimethylolpropane | 96.8 | Trimethylolpropane | 99 |
| formal acrylate | | formal acrylate | |
| (SR ® 531) | | (SR ® 531) | |
| Speedcure ® 939 | 2 | Vanax ® 808 HP | 1 |
| Cu(OAc)₂ | 0.2 | | |
| Difluoroacetic acid | 1 | | |
| TOTAL | 100 | TOTAL | 100 |

Component A and component B are mixed, in a 1:1 volume ratio using a Sulzer ® Mixpac mixer at an ambient temperature of 23° C.

### Example 4: Preparation of Composition 4 (Comparative Example with MMA)

The ingredients of component A are mixed in the proportions shown in the following table, at a temperature of 23° C., in a continuously stirred mixer and under nitrogen. The various ingredients constituting component B are mixed in the proportions shown in the following table, at a temperature of 23° C., in a continuously stirred mixer and under nitrogen.

Composition 4

| Component A | | Component B | |
|---|---|---|---|
| | % by weight | | % by weight |
| | (relative to | | (relative to |
| | the total | | the total |
| Ingredients | weight of A) | Ingredients | weight of B) |
| MMA | 96.8 | MMA | 99 |
| Speedcure ® 939 | 2 | Vanax ® 808 HP | 1 |
| Cu(Acac)₂ | 0.2 | | |
| Difluoroacetic acid | 1 | | |
| TOTAL | 100 | TOTAL | 100 |

Component A and component B are mixed, in a 1:1 volume ratio using a Sulzer ® Mixpac mixer at an ambient temperature of 23° C.

### Example 5: Performance of the Compositions

The adhesive bonding tests were performed under the following conditions:
Application of composition 1, 2, 3 or 4 (obtained, respectively, in Examples 1, 2, 3 and 4 by mixing components A and B using a Sulzer® Mixpac mixer) on a first glass microscope slide (25 x 76 mm);
-Affixing a second glass microscope slide (25 x 76 mm) onto the first slide which received composition 1, 2, 3 or 4;
Step of sliding the two microscope slides to enable equal distribution of composition 1, 2, 3 or 4 between the two slides (the oxygen exposure is reduced here). The time at which point it is no longer possible to separate the two slides is recorded.

The reactivity (exotherm) is analyzed continuously using a pyrometer and by thermal imaging. The gel time (or lag time) is the time it takes for the sample to start polymerizing.

The time/temperature profiles were produced using an Omega OS552-V1-6 industrial infrared thermometer (Omega Engineering®, Inc., Stamford, CT) accurate to ±1° C. for 2 g (about 4.0 mm height) and 0.25 g (1.4 mm height) of polymerization.

The results are collated in the following table:

| | | | | Adhesive | |
|---|---|---|---|---|---|
| | | | Temperature | bonding time | |
| | Gel | | peak | for a thickness | |
| Composition | time (s) | | (in ° C.) | of 300 microns | Comments |
| Composition 1 | 10 | min | 110° C. | 12 min | tacky |
| (Example 1) | | | | | |
| Composition 2 | 26 | s | 120° C. | 1 min 30 sec | tacky |
| (Example 2) | | | | | |
| Composition 3 | 34 | s | 100° C. | 1 min 30 sec | tacky |
| (Example 3) | | | | | |
| Composition 4 | Not | | — | Not | — |
| (comparative | polymerized | | | polymerized | |
| example 4) | | | | | |

As emerges from this table, compositions 1, 2 and 3 (according to the invention) advantageously polymerize quickly (after mixing components A and B), in view of their short gel times (10 min, 26 sec et 34 sec, respectively). The gel times are advantageously considerably shorter in the presence of copper complex. On the other hand, it was observed that comparative composition 4 (example 4) does not polymerize in the open air.

In addition, compositions 1, 2 and 3 advantageously lead to bonding with faster setting times than the comparative composition 4.

1-16. (canceled)

17. A crosslinkable two-component composition comprising:
a component A comprising:
an iodonium salt having one of the formulae (I-A), (I-B) or (I-C) below: 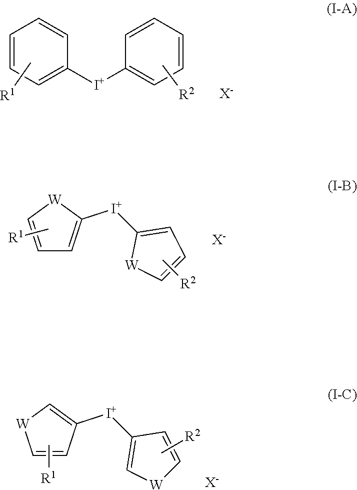
in which:
R¹ and R² each represent, independently of each other, a hydrogen atom, an alkyl radical, an alkenyl radical, a cycloalkyl radical, a cycloalkenyl radical, an aryl radical, a chlorine atom, a bromine atom, an iodine atom, a carboxylic radical, or an —NO₂ radical;
X⁻ represents a monovalent anion; and
W represents O or S;
an organic or mineral acid having a pKa or pKa1 ranging from 0.3 to 5 measured in water at 25° C.;
at least one (meth)acrylate monomer M1 having one of the formulae (II), (III) or (IV) below: 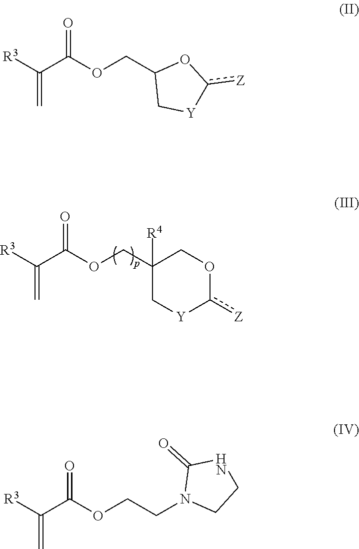
in which:
R³ represents H or a methyl;
R⁴ represents H, methyl or ethyl;
p represents 0 or 1; and
Z represents H, O, S, an alkyl group, a benzyl group, an aryl group or an alkoxy group;
Y represents O, S, NH or CH₂; [symbol]
is a single bond or a double bond,
on condition that when Z represents O, then the bond [symbol] is a double bond;
optionally a copper salt of formula (V-1) or a copper complex of formula (V-2): 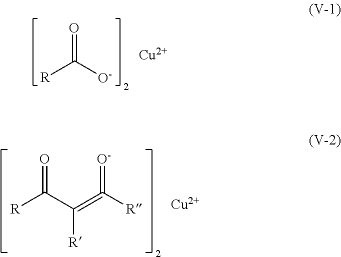
in which:
R and R″ each represent, independently of each other, an alkyl radical, a cycloalkyl radical, an aryl radical or a heteroaryl radical,
R′ represents a hydrogen atom, an alkyl radical, a cycloalkyl radical, an aryl radical or a heteroaryl radical,
or R and R′ (or R′ and R″) may also be engaged in one and the same ring comprising from 5 to 8 carbon atoms, said ring optionally comprising at least one heteroatom;
a component B comprising at least one dihydropyridine compound having one of the formulae (VI) to (X) below: 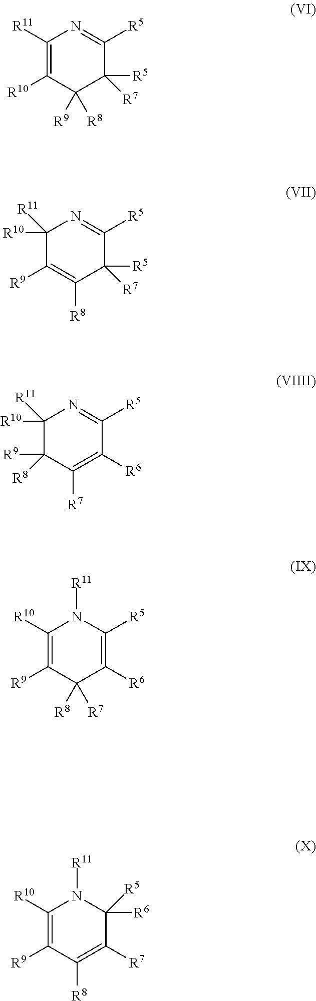
in which:
each of the radicals R⁵ to R¹¹ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a}; said alkyl, alkenyl, alkynyl, cycloalkyl, heterocycloalkyl, heteroalkyl, aryl, alkylaryl and arylalkyl groups being optionally substituted; and R^{a}represents an alkyl or aryl radical;
or two radicals from among R⁵ to R¹¹ together form an optionally substituted monocyclic or polycyclic ring;
said crosslinkable two-component composition not comprising any peroxide.

18. The composition as claimed in claim 17, characterized in that, in formula (I-A) or (I-B) or (I-C), X⁻ represents F⁻, Cl⁻, Br⁻, I⁻, NO₃⁻, HSO₄⁻, H₂PO₄⁻, HCOO⁻, CH₃COO⁻, BF₄⁻, AsF₆⁻, PF₆⁻, CH₃—Ph—SO₃⁻, SbF₆⁻ or (F₅Ph)₄B⁻.

19. The composition as claimed in claim 17, characterized in that the iodonium salt of formula (I-A) or (I-B) or (I-C) is chosen from diphenyliodonium hexafluorophosphate, diphenyliodonium fluoroborate, diphenyliodonium 2-carboxylate, bis(4-tert-butylphenyl)iodonium hexafluorophosphate, 3,3′-dimethyldiphenyliodonium hexafluorophosphate and (4-isopropylphenyl)(4-methylphenyl)iodonium tetrakis(pentafluorophenyl)borate.

20. The composition as claimed in claim 17, characterized in that the iodonium salt is (4-isopropylphenyl)(4-methylphenyl)iodonium tetrakis(pentafluorophenyl)borate.

21. The composition as claimed in claim 17, in which the total content of iodonium salt of formula (I-A) or (I-B) or (I-C) ranges from 0.05% to 5.0% by weight, relative to the total weight of said crosslinkable two-component composition.

22. The composition as claimed in claim 17, characterized in that the (meth)acrylate monomer M1 is chosen from the following monomers:

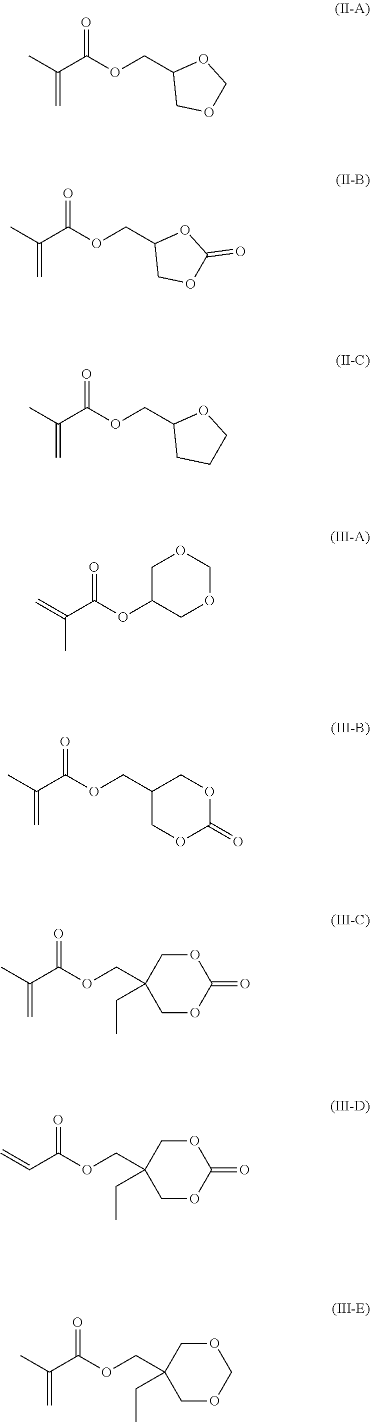

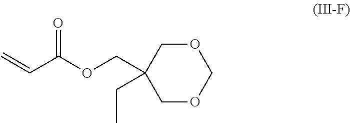

23. The composition as claimed in claim 17, characterized in that the total content of (meth)acrylate monomer(s) M1 ranges from 20% to 99% by weight, relative to the total weight of said crosslinkable two-component composition.

24. The composition as claimed in claim 17, characterized in that the copper salt of formula (V-1) is copper acetate, and the copper complex of formula (V-2) is copper acetylacetonate.

25. The composition as claimed in claim 17, characterized in that the dihydropyridine compound has the formula (IX) or (X) as defined in claim 17.

26. The composition as claimed in claim 17, characterized in that the dihydropyridine compound is chosen from the following compounds:

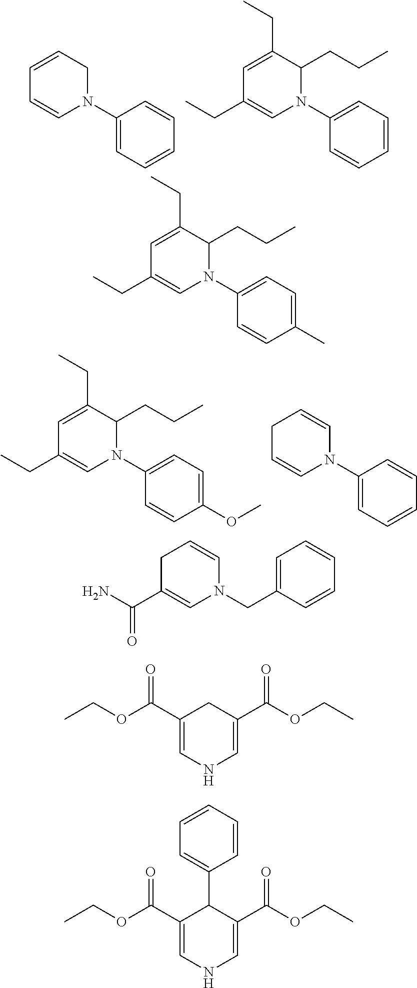

27. The composition as claimed in claim 17, characterized in that the mole ratio of dihydropyridine compound(s) of formulae (VI) to (X)/iodonium salt(s) of formula (I-A) or (I-B) or (I-C) ranges from 0.25 to 9 in said composition.

28. The composition as claimed in claim 17, characterized in that the acid having a pKa or pka1 ranging from 0.3 to 5 is an organic acid chosen from carboxylic acids.

29. The composition as claimed in claim 17, characterized in that the acid has a pka or pka1 ranging from 2 to 5.

30. The composition as claimed in claim 17, characterized in that the composition does not comprise any hydroxyalkyl (meth)acrylate.

31. An adhesive, mastic or coating comprising the composition as defined in claim 17.

32. A process for assembling two substrates by adhesive bonding, comprising:
the coating, onto at least one of the two substrates to be assembled, of a composition obtained by mixing components A and B as defined in claim 17; and then
bringing the two substrates into effective contact; and
crosslinking the composition.
